(19) United States
(12) Patent Application Publication
(10) Pub. No.: US 2014/0152876 A1
(43) Pub. Date: Jun. 5, 2014

(54) IMAGE SYNTHESIS DEVICE AND IMAGE SYNTHESIS METHOD

(71) Applicant: OMRON CORPORATION, Kyoto-shi (JP)

(72) Inventors: Tatsuya ADACHI, Ichinomiya-Shi (JP); Ryoji SHIMIZU, Ichinomiya-Shi (JP); Masashi SATO, Nagoya-shi (JP)

(73) Assignee: OMRON CORPORATION, Kyoto-shi (JP)

(21) Appl. No.: 14/091,749

(22) Filed: Nov. 27, 2013

(30) Foreign Application Priority Data
Dec. 3, 2012 (JP) 2012-264394

(51) Int. Cl. H04N 5/262

(52) U.S. Cl. CPC H04N 5/2621
USPC 348/239

(57) ABSTRACT

An image synthesis device and a corresponding method, including first and second illumination light sources configured to illuminate an object to be detected, a light source controller configured to alternately turn on the light sources, a photographing section configured to photograph the object while the first and second illumination light sources are turned on to generate first and second images, respectively, a storage section configured to store first and second reference images generated by photographing a range of the photographing section where the illumination light sources are turned on and where the object is not present, a difference image generation section configured to generate a first difference image based on a difference between the first image and first reference image and a second difference image based on a difference between the second image and second reference image, and a synthesis section configured to synthesize the first and second difference images to generate a synthetic image.

### CROSS REFERENCE TO RELATED APPLICATIONS

This application is related to and claims the benefit of Japanese Patent Application No. 2012-264394 filed on 3 Dec. 2012, the contents of which are herein incorporated by reference in their entirety.

### TECHNICAL FIELD

The present invention relates to an image synthesis device and an image synthesis method that synthesize a plurality of images obtained by photographing a predetermined object.

### RELATED ART

To allow a player of a game machine such as a slot machine or a pinball game (Pachinko) machine to intuitively understand relevance between an operation by the player and a presentation, a known system provides a motion sensor for detection of a motion of a predetermined object, such as a hand of the player (for example, see Japanese Unexamined Patent Publication No. 2011-193937).

For example, one such a motion sensor utilizes an image obtained by photographing an object to be detected. For example, Japanese Unexamined Patent Publication No. 2011-193937 discloses a technique that analyzes each of a plurality of images obtained by photographing an object to be detected at predetermined time intervals to identify a motion vector of the object to be detected to thereby detect a motion of the object to be detected.

However, when an object that reflects illumination light exists around the object to be detected, a difference in brightness between a pixel corresponding to the object to be detected and a pixel corresponding to a portion around the object to be detected becomes small on an obtained image, making it difficult to recognize the object to be detected, which in turn may result in difficulty in detection of the motion of the object to be detected. Thus, in order for the motion sensor utilizing the image to accurately detect the motion of the object to be detected, it is necessary to generate an image in which the object to be detected is easily identifiable even when there exists an object that reflects illumination light around the object to be detected.

### SUMMARY OF INVENTION

An image synthesis device is provided including a first illumination light source configured to illuminate an object to be detected, a second illumination light source disposed at a different position from the first illumination light source and configured to illuminate the object to be detected, a light source controller configured to alternately turn on the first and second illumination light sources, a photographing section configured to photograph the object to be detected while the first illumination light source is turned on to generate a first image in which the object to be detected is present and configured to photograph the object to be detected while the second illumination light source is turned on to generate a second image in which the object to be detected is present, a storage section configured to store therein a first reference image generated by photographing a photographing range of the photographing section under conditions where the first illumination light source is turned on and where the object to be detected does not exist in the photographing range and a second reference image generated by photographing the photographing range under conditions where the second illumination light source is turned on and where the object to be detected does not exist in the photographing range, a difference image generation section configured to generate a first difference image based on a difference between the first image and first reference image and a second difference image based on a difference between the second image and second reference image, and a synthesis section configured to synthesize the first and second difference images to generate a synthetic image.

An image synthesis method is further provided, including alternately turning on a first illumination light source and a second illumination light source disposed at a different position from the first illumination light source, photographing an object to be detected using a photographing section while the first illumination light source is turned on to generate a first image in which the object to be detected is present, photographing the object to be detected using the photographing section while the second illumination light source is turned on to generate a second image in which the object to be detected is present, generating a first difference image based on a difference between the first image and a first reference image generated by photographing a photographing range of the photographing section under conditions where the first illumination light source is turned on and where the object to be detected does not exist in the photographing range, generating a second difference image based on a difference between the second image and a second reference image generated by photographing the photographing range under conditions where the second illumination light source is turned on and where the object to be detected does not exist in the photographing range, and synthesizing the first and second difference images to generate a synthetic image.

### BRIEF DESCRIPTION OF THE DRAWINGS

FIG. 1 is a schematic configuration view of a motion sensor in which an image synthesis device according to an embodiment of the present invention is implemented;

FIG. 2 is a view illustrating an example of arrangement of illumination light sources;

FIG. 3 is a functional block diagram illustrating functions to be executed by a processing section;

FIG. 4 is a view illustrating a relationship between light-on period of the illumination light sources and an image photographing timing;

FIG. 5A is an example of a first image obtained by photographing a hand when a first illumination light source is turned on, FIG. 5B is an example of a first reference image obtained by photographing a photographing range under conditions where the first illumination light source is turned on and where the hand does not exist in the photographing range; and FIG. 5C is an example of a first difference image between the first image and the first reference image;

FIG. 6A is an example of a second image obtained by photographing the hand when a second illumination light source is turned on, FIG. 6B is an example of a second reference image obtained by photographing a photographing range under conditions where the second illumination light source is turned on and where the hand does not exist in the photographing range; and FIG. 6C is an example of a second difference image between the second image and the second reference image;

FIG. 7 is an example of a synthetic image obtained by synthesizing the first difference image of FIG. 5C and the second difference image of FIG. 6C;

FIG. 8 is an operation flowchart of image synthesis processing;

FIG. 9 is an exemplary view of the synthetic image;

FIG. 10A is a view illustrating a positional relationship between a detection boundary and sub-areas when an object area contacts a lower end of an object area image; and FIG. 10B is a view illustrating a positional relationship between the detection boundary and sub-areas when the object area contacts a right end of the object area image;

FIGS. 11A to 11C illustrate an example of a relationship between a motion of waving the hand as the object to be detected from right to left and transition of the sub-areas in which the hand is detected;

FIG. 12 is an operation flowchart of object motion detection processing executed by the processing section;

FIG. 13 is a schematic perspective view of a pinball game machine provided with the motion sensor incorporating therein the image synthesis device according to the embodiment or modification of the present invention;

FIG. 14 is a circuit block diagram of the pinball game machine;

FIG. 15 is a view illustrating an example of a presentation screen displayed on a display device; and

FIG. 16 is a view illustrating another example of the presentation screen displayed on the display device.

### DETAILED DESCRIPTION

Hereinafter, an image synthesis device and a motion sensor in which the image synthesis device is incorporated according to an embodiment of the present invention will be described with reference to the drawings. The image synthesis device alternately turns on two first and second illumination light sources disposed at different positions, and then photographs a predetermined area while the first illumination light source is lighting to obtain a first image and photographs the predetermined area while the second illumination light source is lighting to obtain a second image. The image synthesis device calculates a difference between the first image and a first reference image obtained by photographing the predetermined area when the first illumination light source is lighting and an object to be detected does not exist in the predetermined area to obtain a first difference image. Similarly, the image synthesis device calculates a difference between the second image and a second reference image obtained by photographing the predetermined area when the second illumination light source is lighting and the object to be detected does not exist in the predetermined area to obtain a second difference image. Then, the image synthesis device synthesizes the first and second difference images. In this configuration, even when illumination light from the first illumination light source is reflected or scattered by an object located near the object to be detected to reach a photographing section to eliminate a difference in brightness between a part corresponding to the object to be detected and a part corresponding to a portion around the object to be detected, illumination light from the second illumination light source reflected by the object located near the object to be detected does not reach the photographing section, ensuring a large brightness difference between the part corresponding to the object to be detected and part corresponding to the portion around the object to be detected on an obtained image. Thus, by synthesizing the images obtained when the different illumination light sources are lighting as described above, a synthetic image in which the object to be detected is easily identifiable can be obtained.

In the present embodiment, the object to be detected is a hand of a player. Moreover, a predetermined motion to be detected by the motion sensor is a hand waving of the player made with his or her wrist fixed.

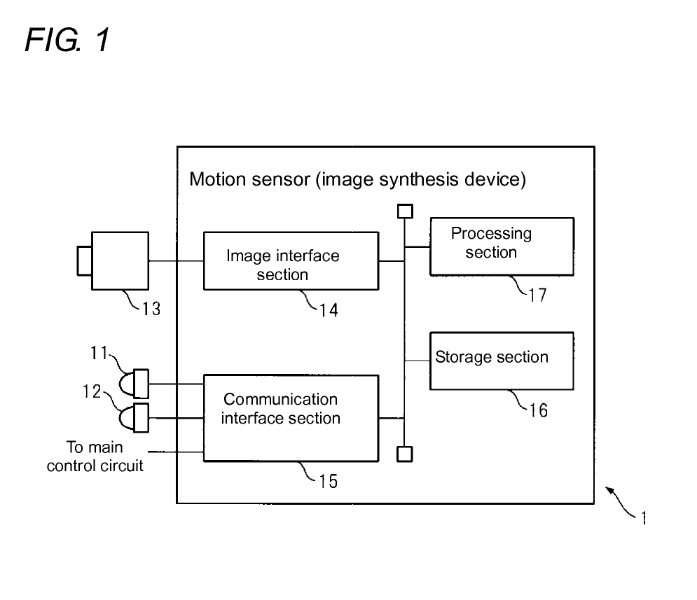

FIG. 1 is a schematic configuration view of a motion sensor in which an image synthesis device according to an embodiment of the present invention is implemented. A motion sensor 1 includes a first illumination light source 11, a second illumination light source 12, a photographing section 13, an image interface section 14, a communication interface section 15, a storage section 16, and a processing section 17. The first illumination light source 11, the second illumination light source 12, and the photographing section 13 are disposed on a front surface of a game machine. The image interface section 14, the communication interface section 15, the storage section 16, and the processing section 17 are implemented, as one integrated circuit, on a control board disposed inside or on a back of the game machine.

The first and second illumination light sources 11 and 12 illuminate a hand as the object to be detected. To this end, the first and second illumination light sources 11 and 12 each have at least one infrared-emitting diode and a drive circuit for supplying current to the infrared-emitting diode. The first and second illumination light sources 11 and 12 are disposed at different positions from each other. The drive circuit of each illumination light source supplies current to the infrared-emitting diode while a control signal from the processing section 17 is ON; while the drive circuit interrupts the current supply to the infrared-emitting diode while the control signal from the processing section 17 is OFF. The first and second illumination light sources 11 and 12 are alternately turned on in accordance with a photographing period of the photographing section 13 such that one of the first and second illumination light sources 11 and 12 is turned on while the other one of them is turned off.

The photographing section 13 is a camera (e.g., an infrared camera) having a sensitivity to a wavelength of the illumination light emitted by the first and second illumination light sources 11 and 12 and is disposed such that the object to be detected is included in a photographing range thereof. The photographing section 13 photographs its photographing range with a predetermined photographing period to generate an image corresponding to the photographing range. The photographing section 13 outputs the image to the image interface section every time the image is generated. The photographing period is, e.g., 33 msec.

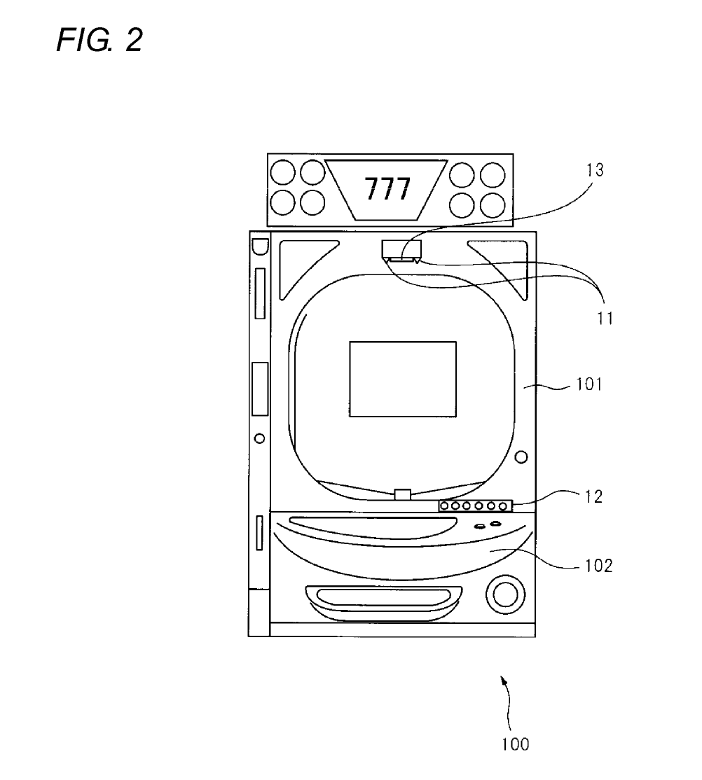

FIG. 2 is a view illustrating an example of arrangement of the illumination light sources and photographing section disposed in a pinball game machine. As illustrated in FIG. 2, the photographing section 13 is disposed near an upper end center portion of a front surface of a game board 101 of a pinball game machine 100 so as to face downward and includes an area around the front surface of the game board 101 as its photographing range. The first illumination light source 11 is disposed on left and right sides of the photographing section 13 so as to face downward. The second illumination light source 12 is disposed above a ball receiving portion 102 located at a lower portion of the game board 101 so as to face forward (i.e., toward a player) and illuminates a hand of the player from a fingertip side in a state where the player's hand is placed above the ball receiving portion 102.

The image interface section 14 is an interface circuit for connecting to the photographing section 13 and receives an image from the photographing section 13 every time the photographing section 13 generates the image. The image interface section 14 passes the received image to the processing section 17.

The communication interface section 15 has an interface circuit for connecting, e.g., a main control circuit (not illustrated) of the game machine and the motion sensor 1. Upon receiving, from the main control circuit, a control signal instructing start of processing that detects a specific motion of the object to be detected, the communication interface section 15 passes the control signal to the processing section 17. Moreover, upon receiving, from the processing section 17, a signal indicating that the specific motion of the object to be detected is detected, the communication interface section 15 passes the signal to the main control circuit.

Moreover, the communication interface section 15 is connected to the first and second illumination light sources 11 and 12 and outputs a control signal for controlling turning on/off of the first and second illumination light sources 11 and 12.

The storage section 16 includes a readable and writable non-volatile semiconductor memory and a readable and writable volatile semiconductor memory. The storage section 16 temporarily stores therein the image received from the photographing section 13 for a time period required for the processing section 17 to complete object motion detection processing. The storage section 16 further stores therein various information used by the processing section 17 to generate a synthetic image. For example, the various information includes a reference image which is an image generated for each illumination light source generated by photographing the photographing range by the photographing section 13 under conditions where the illumination light source is turned on and where the object to be detected does not exist within the photographing range.

Moreover, the storage section 16 may store various data used in the object motion detection processing. For example, the various data includes a flag indicating a detected moving direction of the object to be detected and various intermediate calculation results obtained during execution of the object motion detection processing.

The processing section 17 includes one or more processors and a peripheral circuit thereof. The processing section 17 generates, from the first and second images received from the photographing section 13, a synthetic image that facilitates identification of the object to be detected. Moreover, the processing section 17 analyzes successively generated synthetic images to determine whether or not the hand, (as an example of the object to be detected), is waved (as an example of the predetermined motion).

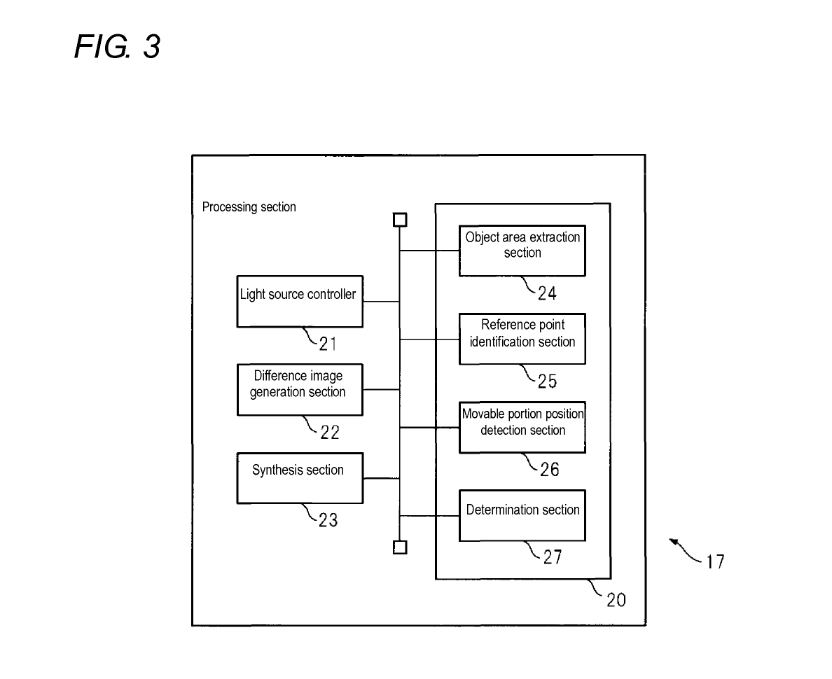

FIG. 3 is a functional block diagram illustrating functions to be executed by the processing section 17. As illustrated in FIG. 3, the processing section 17 includes a light source controller 21, a difference image generation section 22, a synthesis section 23, an object area extraction section 24, a reference point identification section 25, a movable portion position detection section 26, and a determination section 27. The light source controller 21, the difference image generation section 22, and the synthesis section 23 constitute a part of the image synthesis device and used for image synthesis processing. The object area extraction section 24, the reference point identification section 25, the movable portion position detection section 26, and the determination section 27 are used for the object motion detection processing.

The light source controller 21 controls turning on/off of the first and second illumination light sources 11 and 12. In the present embodiment, the light source controller 21 alternately turns on the first and second illumination light sources 11 and 12 in accordance with the photographing period of the photographing section 13.

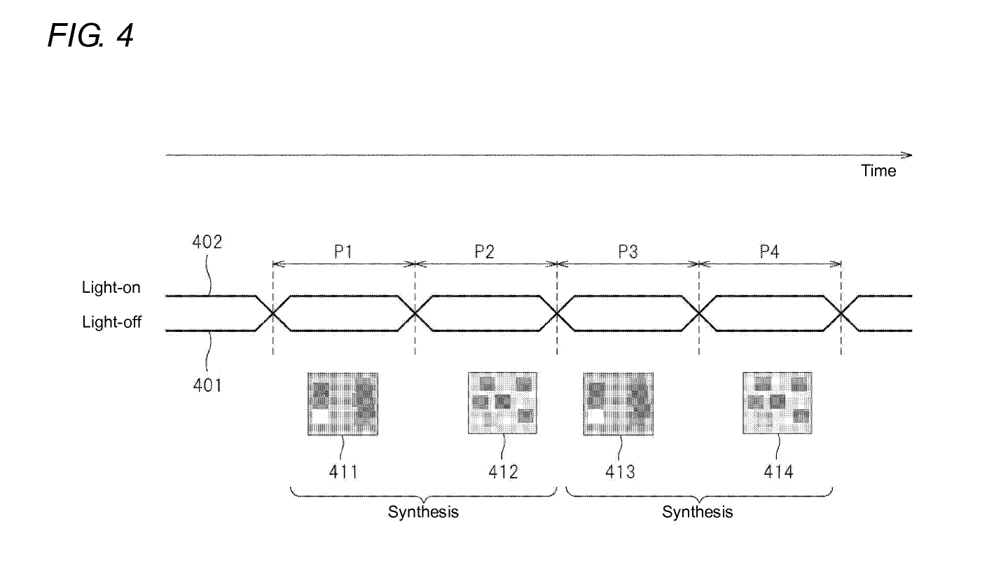

FIG. 4 is a view illustrating a relationship between the photographing period of the photographing section 13 and light-on period of the first and second illumination light sources 11 and 12.

In FIG. 4, a horizontal axis represents time and a vertical axis represents a light-on or a light-off state. Line 401 represents a light-on state of the first illumination light source 11, and line 402 represents a light-on state of the second illumination light source 12. Photographing periods P1, P2, . . . each represent a time period (e.g., 33 msec) required for the photographing section 13 to perform a single photographing operation. As indicated by line 401, in the photographing periods P1, P3, . . . , with the first illumination light source 11 turned on and the second illumination light source 12 turned off, images 411, 413, . . . are generated, respectively, by the photographing section 13. On the other hand, in the photographing periods P2, P4, . . . , with the second illumination light source 12 turned on and the first illumination light source 11 turned off, images 412, 414, . . . are generated, respectively, by the photographing section 13. Then, as described later, a synthetic image is generated from the two images generated in consecutive two photographing periods. That is, a synthetic image is generated once in a period twice the photographing period of the photographing section 13 (e.g., once in 66 msec). For example, a synthetic image is generated from the images 411 and 412, and a subsequent image is generated from the images 413 and 414.

Hereinafter, for descriptive convenience, an image photographed by the photographing section 13 while the first illumination light source 11 is turned on is referred to as a “first image”, and an image photographed by the photographing section 13 while the second illumination light source 12 is turned on is referred to as a “second image”.

The light source controller 21 outputs a control signal (e.g., a 5 V signal) turning on the first illumination light source 11 and a control signal (e.g., a 0 V signal) turning off the second illumination light source 12 during the photographing period within which the first illumination light source 11 is turned on while the motion sensor 1 is executing the object motion detection processing. On the other hand, the light source controller 21 outputs a control signal turning off the first illumination light source 11 and a control signal turning on the second illumination light source 12 during the photographing period within which the second illumination light source 12 is turned on.

The difference image generation section 22 generates a first difference image based on a difference (so-called a background difference) between the first image and a first reference image every time the processing section 17 receives the first image from the photographing section 13. Similarly, the difference image generation section 22 generates a second difference image based on a difference between the second image and a second reference image every time the processing section 17 receives the second image from the photographing section 13.

The first reference image is an image generated by photographing the photographing range of the photographing section 13 under conditions where the first illumination light source 11 is turned on and where the object to be detected does not exist within the photographing range. The second reference image is an image generated by photographing the photographing range of the photographing section 13 under conditions where the second illumination light source 12 is turned on and where the object to be detected does not exist within the photographing range. The first and second reference images are generated upon power-on of the game machine in which the motion sensor 1 is mounted, upon entering of a game ball into a prize winning device, or upon installation of the game machine in a hall of a game parlor, and stored in the storage section 16.

In the present embodiment, the difference image generation section 22 calculates a difference value by subtracting a brightness value of each pixel of the first reference image from a brightness value of a corresponding pixel of the first image and sets the calculated difference value as a value of a corresponding pixel of the first difference image. A value of a pixel whose difference value is negative is set to “0”.

The difference image generation section 22 passes the first and second difference images to the synthesis section 23.

The synthesis section 23 generates a synthetic image by synthesizing the first and second difference images. Specifically, the synthesis section 23 adds a value of each pixel of the first difference image and a value of a corresponding pixel of the second difference image and sets the obtained value as a value of a corresponding pixel of the synthetic image. The sum of the pixel values exceeding an upper limit value (e.g., 255) of the pixel value of the synthetic image is set to the upper limit (255).

The synthesis section 23 stores the generated synthetic image in the storage section 16 for use in the object motion detection processing.

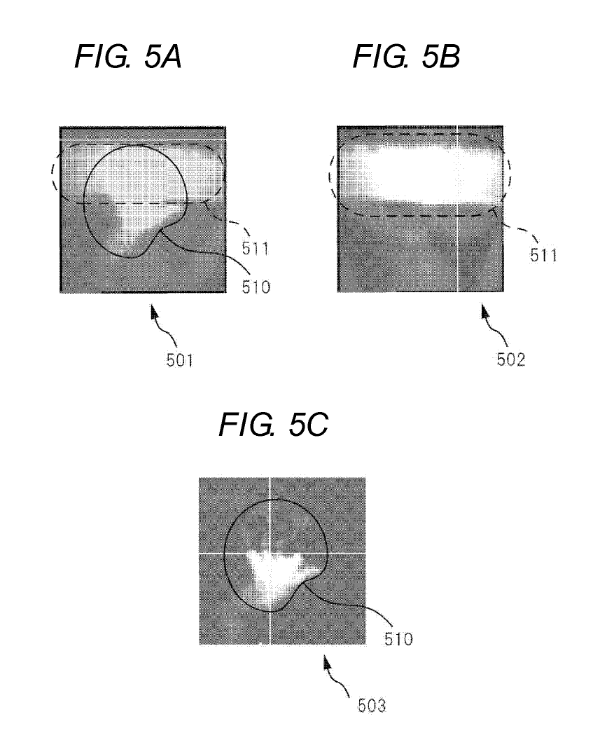

FIG. 5A is an example of the first image, FIG. 5B is an example of the first reference image, and FIG. 5C is an example of the first difference image between the first image and first reference image.

In a first image 501, an object 511 (e.g., ball saucer) located below a hand 510 as the object to be detected reflects or scatters light from the first illumination light source 11, so that a difference in brightness between pixels corresponding to the object 511 and pixels corresponding to the hand 510 is small. Thus, in the image 501, it is difficult to identify fingertips of the hand 510. In a first reference image 502, the hand does not show up, so that only pixels corresponding to the object 511 appear bright. Thus, as illustrated in FIG. 5C, in a first difference image 503, only a palm of the hand 510 can be clearly identified.

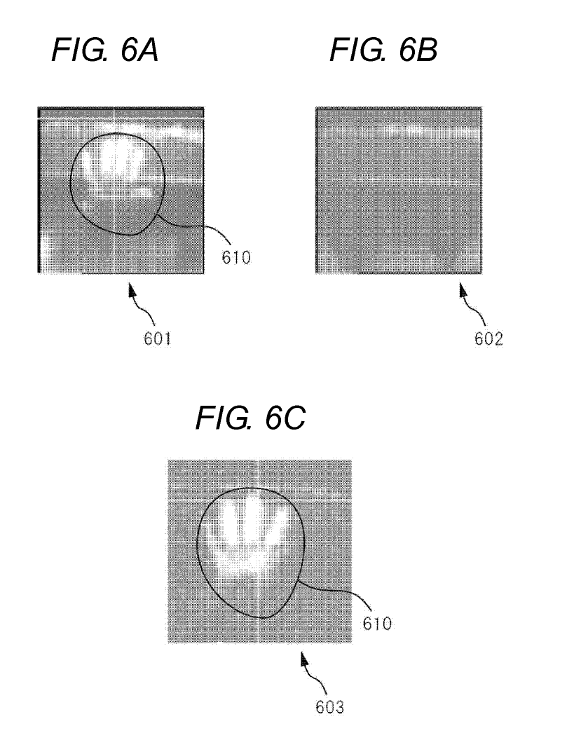

FIG. 6A is an example of the second image, FIG. 6B is an example of the second reference image, and FIG. 6C is an example of the second difference image between the second image and second reference image.

In a second image 601, a hand 610 is illuminated by the second illumination light source 12 from the fingertip side, so that pixels corresponding to the fingertips of the hand 610 appear bright. On the other hand, light from the second illumination light source 12 does not reach the palm of the hand 610, so that pixels corresponding to the palm are as dark as pixels corresponding to an area where the hand does not show up. Moreover, an installation position of the first illumination light source 11 and that of the second illumination light source 12 differ from each other, light reflected or scattered by an object located below the hand 610 hardly reaches the photographing section 13, unlike in the first image of FIG. 5A. Thus, in the second image 601, pixels corresponding to the object located below the hand 610 also appear dark. Similarly, in a second reference image 602, the illumination light from the second illumination light source 12 hardly reaches the photographing section 13, so that the entire second reference image 602 appears dark. Thus, as shown in FIG. 6C, the fingertips of the hand 610 can be clearly identified in a second difference image 603.

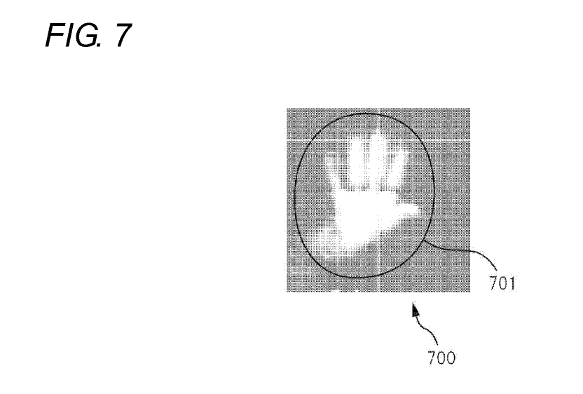

FIG. 7 is a synthetic image obtained by synthesizing the first difference image 503 of FIG. 5C and second difference image 603 of FIG. 6C. The palm appears bright in the first difference image 503, while the fingertips appear bright in the second difference image 603, so that a hand 701 in a synthetic image 700 appears bright as a whole so as to be easily identifiable.

Thus, by synthesizing two images with different illumination directions with respect to the object to be detected, the object to be detected is easily identifiable on the synthetic image.

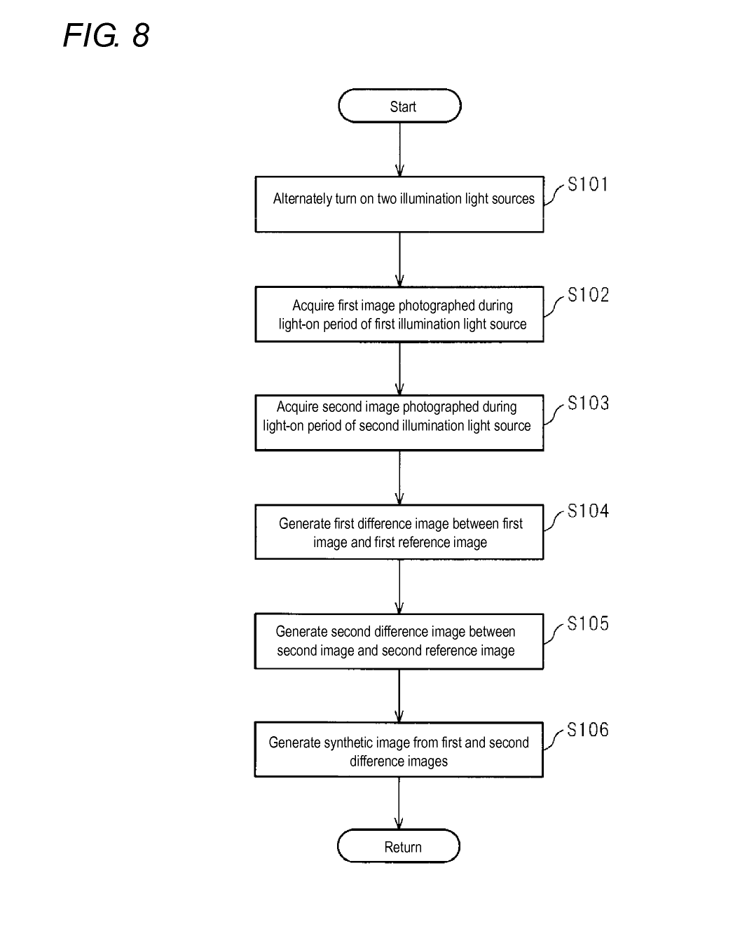

FIG. 8 is an operation flowchart of image synthesis processing.

The light source controller 21 of the processing section 17 alternately turns on the first illumination light source 11 and second illumination light source 12 (step S101). The processing section 17 acquires, from the photographing section 13, the first image obtained by the photographing section 13 photographing its photographing range during the light-on period of the first illumination light source 11 (step S102). Meanwhile, the processing section 17 acquires, from the photographing section 13, the second image obtained by the photographing section 13 photographing its photographing range during the light-on period of the second illumination light source 12 (step S103).

Upon reception of the first image, the difference image generation section 22 of the processing section 17 reads the first reference image from the storage section 16 and generates the first difference image based on a difference between the first image and first reference image (step S104). Similarly, upon reception of the second image, the difference image generation section 22 of the processing section 17 reads the second reference image from the storage section 16 and generates the second difference image based on a difference between the second image and second reference image (step S105).

The synthesis section 23 of the processing section 17 synthesizes the first and second difference images to generate a synthetic image and stores the generated synthetic image in the storage section 16 (step S106). Then, the processing section 17 ends the image synthesis processing.

The following describes the object motion detection processing to be performed based on the synthetic image. The object area extraction section 24 extracts an object area which is an area corresponding to the object to be detected from the synthetic image every time the synthetic image is generated.

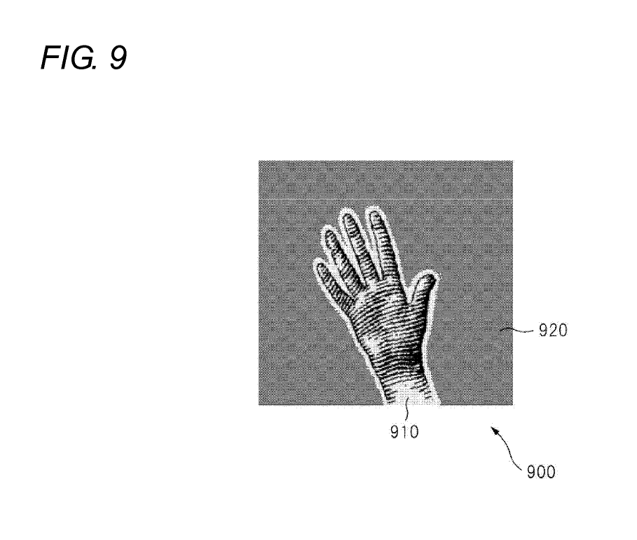

FIG. 9 is an exemplary view of the synthetic image. In the present embodiment, the photographing section 13 is an infrared camera, so that a brightness of a portion corresponding to a heat source existing in the photographing range is higher than a brightness of a portion having no heat source. Accordingly, in an image 900, a brightness of an object area 910 corresponding to the player's hand is higher than a brightness of a background area 920 where the hand does not show up, that is, the object area 910 appears white.

Referring again to FIG. 3, the object area extraction section 24 extracts, from pixels of the synthetic image, pixels each having a brightness higher than a predetermined brightness threshold. Then, the object area extraction section 24 applies labeling processing to the extracted pixels to calculate an area including a set of adjacent pixels that have been extracted. When the number of pixels included in the area is equal to or larger than an area threshold corresponding to an area of the hand estimated on the image, the object area extraction section 24 recognizes the area as the object area.

The brightness threshold may be an average value of the brightness values of the pixels on the image or a minimum value of the brightness values of the pixels corresponding to part of the hand which is experimentally determined in advance.

The object area extraction section 24 generates, for each image, a binary picture representing the object area extracted from the image. The binary image is generated such that a value (e.g., “1”) of a pixel included in the object area and a value (e.g., “0”) of a pixel included in the background area differ from each other. Hereinafter, for descriptive convenience, the binary image representing the object area is referred to as “object area image”.

The object area extraction section 24 passes the object area image to the reference point identification section 25 and movable portion position detection section 26.

Every time the synthetic image is generated, the reference point identification section 25 calculates a reference point from the object area on the object area image corresponding to the synthetic image. The reference point represents a boundary between a movable portion of the object to be detected that is moved when the hand as the object to be detected performs the predetermined motion and a fixed portion of the object to be detected that is less moved than the movable portion even when the hand performs the predetermined motion. In the present embodiment, the predetermined motion is a hand waving of the player made with his or her wrist fixed, so that a portion at a more distal point than the wrist corresponds to the movable portion, and the wrist and a portion on an arm side relative to the wrist correspond to the fixed portion.

Thus, in the present embodiment, the reference point identification section 25 identifies, on the synthetic image, pixels corresponding to the wrist or pixels near the pixels corresponding to the wrist as the reference point, based on an outline shape of the object area. Here, in photographing the hand, it is preferable that the hand appears large in the synthetic image to some extent. Therefore, the photographing area of the photographing section 13 does not cover the entire human body. Thus, the object area corresponding to the hand inevitably contacts an end of the image in the vicinity of a portion corresponding to the wrist. In addition, a width of the palm is larger than that of the wrist.

First, the reference point identification section 25 counts the number of pixels that contact the object area for each of upper, lower, left, and right image ends of the object area. Then, the reference point identification section 25 identifies an image end at which the number of pixels that contact the object area is largest. That is, it can be estimated that the wrist is located in the vicinity of the identified image end. For example, in the image 900 of FIG. 9, a lower side image end is identified as the image end at which the portion around the wrist is located.

Subsequently, the reference point identification section 25 counts the number of pixels included in the object area for each pixel line parallel to the image end that contacts the object area over the longest distance. Then, according to the following expression, the reference point identification section 25 calculates a difference in the number of pixels included in the object area between adjacent pixel lines in order starting from the image end.

(1)

Δⱼ=cⱼ₊₁−cⱼ (1)

In the expression (1), cⱼ and cⱼ₊₁ represent the number of pixels included the object area in j-th pixel line from the image end and the number of pixels included the object area in (j+1)-th pixel line from the image end respectively (j is an integer equal to or larger than 0), and Δj represents a difference in the number of pixels included in the object area between the (j+1)-th pixel line from the image end and j-th pixel line from the image end.

The reference point identification section 25 compares the difference Δj in the number of pixels included in the object area between the adjacent pixel lines with a threshold Th in order starting from the image end. Then, the reference point identification section 25 determines that the wrist is positioned in a pixel line j where the difference Δj first exceeds the threshold Th. Then, the reference point identification section 25 sets a gravity center of the object area in the pixel line j as the reference point.

The threshold Th is set to a value corresponding to a change in the amount of a width of the object area from the wrist to palm, for example, 2 to 3.

The reference point identification section 25 notifies the movable portion position detection section 26 of coordinates of the image end contacting the object area and reference point.

Every time the synthetic image is generated, the movable portion position detection section 26 calculates a position of the movable portion within the movable portion side area of the object area relative to the reference point in the object area image corresponding to the synthetic image. In the present embodiment, a portion at a more distal point than the wrist, i.e., a portion including the palm and fingers corresponds to the movable portion. Then, the movable portion position detection section 26 sets a pixel line that is parallel to the image end contacting the object area over the longest distance and including the reference point as a detection boundary for calculating the position of the movable portion. The movable portion position detection section 26 divides an area (hereinafter, referred to as “movable area” for descriptive convenience) on the movable portion side relative to the detection boundary into a plurality of areas along a direction in which the movable portion moves in a motion to be detected. In the present embodiment, the motion to be detected is the hand waving of the player, so that the movable portion moves in a direction substantially perpendicular to a longitudinal direction of the hand, i.e., a direction from the wrist to fingertips. In addition, because of a structure of the hand, the longitudinal direction of the hand and a direction parallel to the image end contacting the object area over the longest distance cross each other. Thus, the movable portion position detection section 26 divides the movable area into a plurality of sub-areas along the direction parallel to the image end contacting the object area over the longest distance. It is preferable that a width of each sub-area is made smaller than the maximum width of the movable portion so as to include a part of the movable portion. With this configuration, when the movable portion moves, a given part of the movable portion moves from one sub-area to another before and after the movement, so that movement of the movable portion can easily be detected.

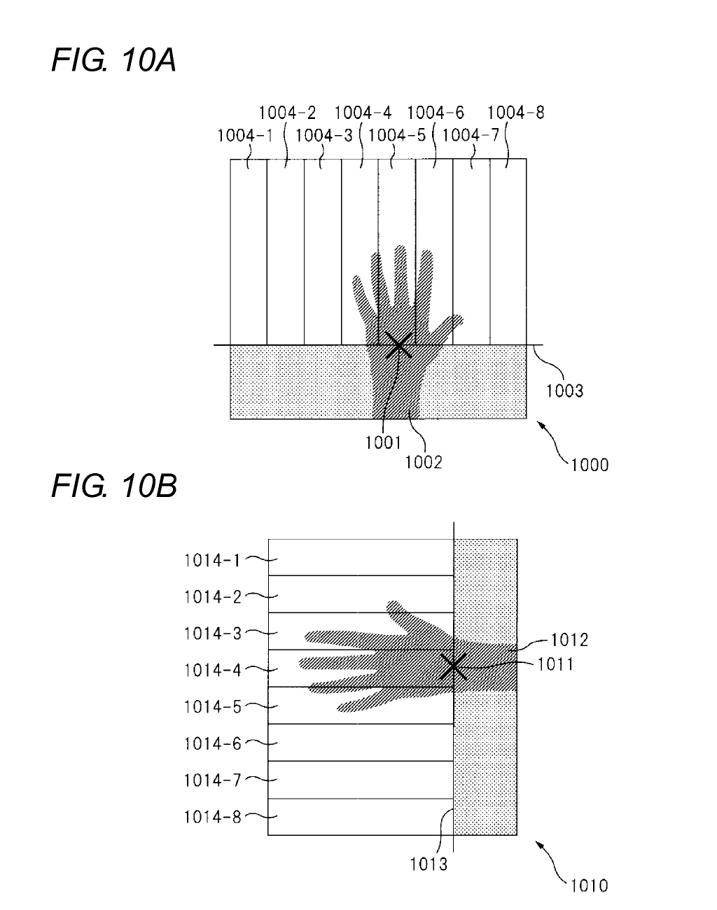

FIG. 10A is a view illustrating a positional relationship between the detection boundary and sub-areas when the object area contacts the lower end of the object area image. FIG. 10B is a view illustrating a positional relationship between the detection boundary and sub-areas when the object area contacts the right end of the object area image. In FIG. 10A, a point 1001 on an object area image 1000 is the reference point. In this example, an object area 1002 contacts the lower end of the object area image 1000, so that a detection boundary 1003 is set so as to pass the reference point 1001 and extend in parallel to the lower end of the object area image 1000. Moreover, the movable area above the detection boundary 1003 is divided into eight sub-areas 1004-1 to 1004-8 in a lateral direction. Similarly, in FIG. 10B, a point 1011 on an object area image 1010 is the reference point. In this example, an object area 1012 contacts the right end of the object area image 1010, so that a detection boundary 1013 is set so as to pass the reference point 1011 and extend in parallel to the right end of the object area image 1010. Thus, the movable area on a left side relative to the detection boundary 1013 is divided into eight sub-areas 1014-1 to 1014-8 in a vertical direction.

With reference again to FIG. 3, the movable portion position detection section 26 then counts, for each sub-area, the number of pixels corresponding to the object area.

The movable portion position detection section 26 compares the number of pixels corresponding to the object area counted for each sub-area with a predetermined threshold Th2. When the counted number of pixels is larger than the threshold Th2, the movable portion position detection section 26 determines that the movable portion of the object to be detected overlaps the sub-area for which the number of pixels is counted. For example, the threshold Th2 is set to a value obtained by multiplying the total number of pixels included in each sub-area by 0.2 to 0.3.

The movable portion position detection section 26 recognizes a gravity center of the sub-areas determined to include the movable portion of the object to be detected as a position of the movable portion and notifies the determination section 27 of an identification number of the sub-area including the gravity center.

The determination section 27 determines whether a difference between a position of the movable portion on the latest synthetic image and a position of the movable portion on a past synthetic image corresponds to the movement of the object to be detected in the predetermined motion thereof. When the determination is affirmative, the determination section 27 determines that the object to be detected performs the predetermined motion.

In the present embodiment, the determination section 27 examines the transition of the sub-area determined to include the object to be detected.

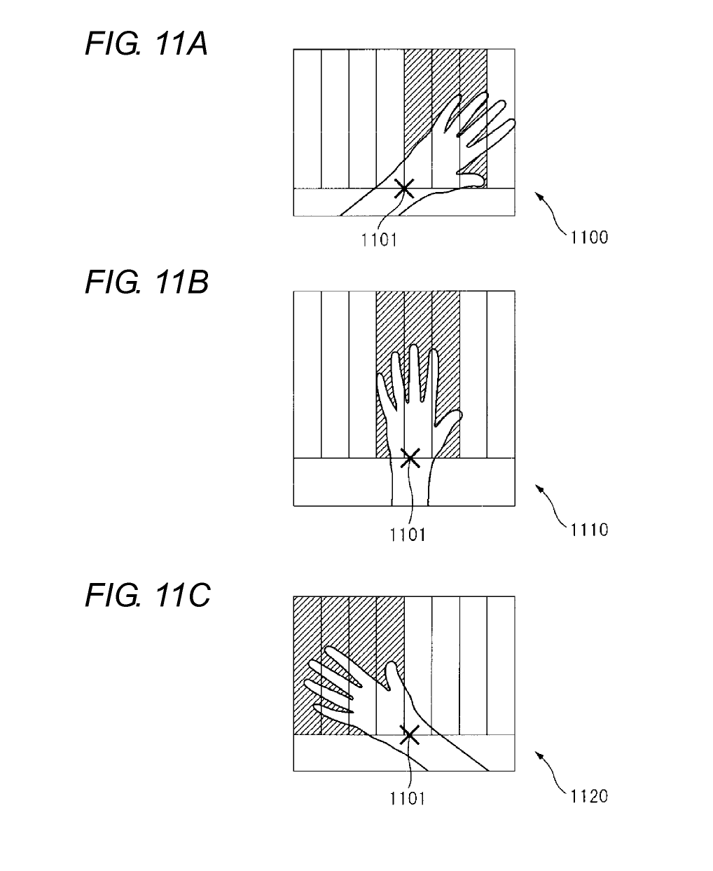

FIGS. 11A to 11C illustrate an example of a relationship between a motion of waving the hand as the object to be detected from right to left and transition of the sub-area in which the hand is detected. In FIGS. 11A to 11C, the movable area is divided into eight sub-areas in the lateral direction. In this example, it is assumed that a synthetic image 1100 of FIG. 11A is generated first, and then a synthetic image 1110 of FIG. 11B and a synthetic image 1120 of FIG. 11C are generated in this order.

As illustrated in FIG. 11A, the hand is located to the right side of the wrist in the first synthetic image 1100. Thus, the hand is disposed in sub-areas located to the right side of the reference point 1101. As illustrated in FIG. 11B, in the second synthetic image 1110, the hand extends straight from bottom to top, so that the hand is disposed in sub-areas located around the reference point 1101. Thereafter, in the third synthetic image 1120 of FIG. 11C, the hand is located to the left side of the wrist, so that the hand is disposed in sub-areas located to the left side of the reference point 1101.

As described above, in the motion of waving the hand, the sub-areas including the hand moves with time beyond the reference point in the movement direction of the hand in the waving motion. In a case where the image end contacting the object area is the upper or lower end, the determination section 27 determines that there occurs the hand waving motion when the gravity center of the sub-areas including the hand moves from left to right or right to left with respect to the reference point. Similarly, in a case where the image end contacting the object area is the right or left end, the determination section 27 determines that there occurs the hand waving motion when the gravity center of the sub-areas including the hand moves from top to bottom or bottom to top with respect to the reference point.

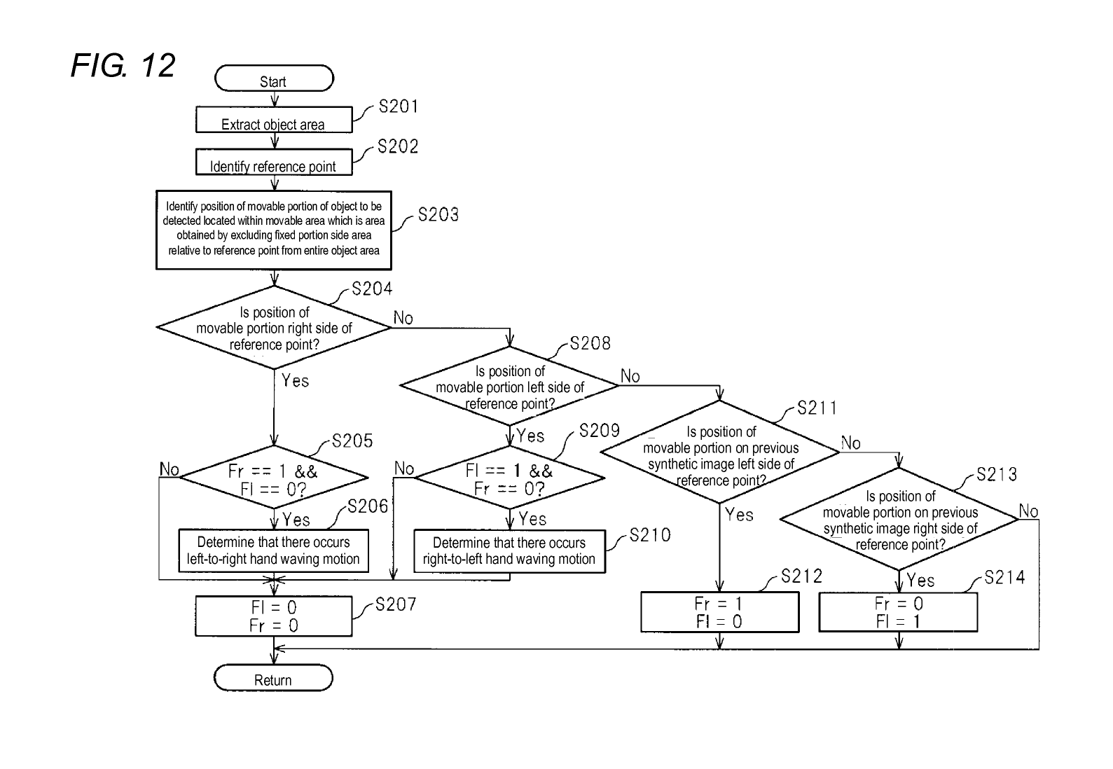

FIG. 12 is an operation flowchart of the object motion detection processing executed by the processing section 17. Every time the synthetic image is generated, the processing section 17 determines whether there occurs the hand waving motion according to the following operation flowchart. In the operation flowchart of FIG. 12, it is assumed that the object area contacts the lower or upper end of the synthetic image and that the processing section 17 detects a left-to-right or right-to-left hand waving motion. In a case where the object area contacts the left or right end of the synthetic image and where the processing section 17 detects a top-to-bottom or bottom-to-top hand waving motion on the synthetic image, terms “left”, “right”, and “lateral direction” in the following operation flowchart shall be replaced with “top”, “bottom”, and “vertical direction”, respectively.

First, the object area extraction section 24 extracts the object area corresponding to the object to be detected on the synthetic image (step S201). Then, the reference point identification section 25 identifies the reference point representing the boundary between the movable portion and fixed portion based on the extracted object area (step S202). The movable portion position detection section 26 identifies the position of the movable portion of the object to be detected located within the movable area which is an area obtained by excluding the fixed portion side area relative to the reference point from the entire object area (step S203).

The determination section 27 determines whether the position of the movable portion is the right side of the reference point (step S204).

When the position of the movable portion is the right side of the reference point (Yes in step S204), the determination section 27 determines whether a rightward movement flag Fr read from the storage section 16 assumes “1” which is a value indicating that the movable portion starts moving from a position in the left side of the reference point and whether a leftward movement flag Fl read from the storage section 16 assumes “0” which is a value indicating that the movable portion does not start moving from a position in the right side of the reference point (step S205).

When the rightward movement flag Fr assumes “1” and the leftward movement flag Fl assumes “0”, that is, when the movable portion starts moving from a position in the left side of the reference point, the determination section 27 determines that there occurs the left-to-right hand waving motion (step S206). After step S206, or when the rightward movement flag Fr assumes “0” or the leftward movement flag Fl assumes “1” in step S205, the determination section 27 sets both the rightward movement flag Fr and leftward movement flag Fl to “0” (step S207).

On the other hand, when the position of the movable portion is not the right side of the reference point (No in step S204), the determination section 27 determines whether the position of the movable portion is the left side of the reference point (step S208).

When the position of the movable portion is the left side of the reference point (Yes in step S208), the determination section 27 determines whether the rightward movement flag Fr assumes “0” and whether leftward movement flag Fl assumes “1”, that is, whether the movable portion starts moving from a position in the right side of the reference point (step 209).

When the rightward movement flag Fr assumes “0” and the leftward movement flag assumes “1”, that is, when the movable portion starts moving from a position in the right side of the reference point, the determination section 27 determines that there occurs the right-to-left hand waving motion (step S210). After step S210, or when the rightward movement flag Fr assumes “1” or the leftward movement flag assumes “0” in step S209, the determination section 27 sets both the rightward movement flag Fr and leftward movement flag Fl to “0” (step S207).

In step S208, when the position of the movable portion is not the left side of the reference point (No in step S208), that is, when the position of the movable portion in the lateral direction is substantially equal to a position of the reference point in the lateral direction, the determination section 27 determines whether the position of the movable potion on a previous synthetic image is the left side of the reference point (step S211). When the position of the movable potion on the previous synthetic image is the left side of the reference point (Yes in step S211), the determination section 27 determines that the movable portion starts moving from a position in the left side of the reference point and sets the rightward and leftward movement flags Fr and Fl to “1” and “0”, respectively (step S212).

On the other hand, when the position of the movable portion on the previous synthetic image is not the left side of the reference point (No in step S211), the determination section 27 determines whether the position of the movable portion on the previous synthetic image is the right side of the reference point (step S213). When the position of the movable portion on the previous synthetic image is the right side of the reference point (Yes in step S213), the determination section 27 determines that the movable portion starts moving from a position in the right side of the reference point and sets the rightward and leftward movement flags Fr and Fl to “0” and “1”, respectively (step S214). On the other hand, when the position of the movable portion on the previous synthetic image is not the right side of the reference point (No in step S213), that is, when the lateral direction position of the movable portion on the previous synthetic image is substantially equal to the position of the reference point in the lateral direction, the determination section 27 does not update both the rightward and leftward movement flags Fr and Fl.

After step S207, S212, or S214, the determination section 27 stores values of the rightward and leftward movement flags Fr and Fl in the storage section 16. Thereafter, the processing section 17 ends the object motion detection processing.

In a case where a time required for completing a single hand waving motion is shorter than a generation period of the synthetic image, that is, twice the photographing period of the photographing section 13, the determination section 27 may determine that the hand waving motion occurs by detecting that the movable portion is located in the right side (or in the left side) of the reference point after detecting the movable portion is located in the left side (or in the right side) of the reference point without checking whether the lateral direction position of the movable portion and lateral direction position of the reference point substantially coincide with each other as described in the above flowchart.

As described above, in the image synthesis device, two images obtained by photographing the object to be detected in a state where one of two first and second illumination light sources disposed at different positions are synthesized. Thus, in the image synthesis device, even when the illumination light from the first illumination light source is reflected or scattered by an object other than the object to be detected to reach the photographing section to make a part of the object to be detected difficult to identify on the image, an image obtained by photographing the object to be detected in a state where the object to be detected is illuminated by the second light source that is disposed at a different position from the first illumination light source can be utilized, so that it is possible to obtain a synthetic image in which the object to be detected is easily identifiable.

Moreover, the motion sensor incorporating therein the image synthesis device detects the motion of the object to be detected based on a plurality of successively obtained synthetic images each in which the object to be detected is easily identifiable, thereby accurately detecting the motion of the object to be detected.

According to a modification, the reference point identification section 25 may identify the reference point with respect to one of the plurality of successively generated synthetic images and apply the set reference point to the remaining synthetic images. This is because it is estimated that the position of the reference point hardly changes during the predetermined motion.

According to another modification, the movable portion position detection section 26 does not necessarily set the sub-areas in the movable area but may calculate a gravity center of a portion included in the movable area within the object area as the position of the movable portion. According to a still another modification, in a case where the movable portion position detection section 26 calculates the gravity center of a portion included in the movable area within the object area as the position of the movable portion, the determination section 27 may calculate a distance between the position of the movable portion on the synthetic image generated at a given time point and the position of the movable portion on each of the plurality of synthetic images generated within a subsequent predetermined time period. When the calculated distance is equal to or larger than a distance threshold corresponding to the hand wave motion, the determination section 27 may determine that there occurs the hand waving motion.

The motion to be detected is not limited to the hand waving motion. According to a modification, the motion sensor may detect a hand grasping motion or a hand opening motion. In this case, the movable portion position detection section 26 may calculate a distance between the position of the wrist as the reference point and a position of each of pixels on the boundary of the object area located on the movable area side and set the position corresponding to a pixel for which the calculated distance is largest, that is, a distal end of the movable portion as the position of the movable portion. Then, when a distance between the position of the distal end of the movable portion on the synthetic image generated at a given time point and a position of the distal end of the movable portion on a subsequently generated synthetic image is equal to or larger than a threshold corresponding to a difference in fingertip position between the cases where the hand is clenched and where the hand is opened, the determination section 27 may determine that there occurs the hand grasping motion or hand opening motion.

Moreover, the object to be detected is not limited to the hand. For example, the object to be detected may be any one of fingers. Moreover, the motion to be detected may be a finger flexing motion or a finger stretching motion. In this case, the reference point identification section 25 identifies a position corresponding to a finger base on the synthetic image as the reference point. For example, the reference point identification section 25 calculates, in order from the image end opposed to the image end contacting the object area, the number of the object areas which are located on each of the pixel lines parallel to the image end contacting the object area and segmentalized by the background area. Then, it may be determined that the finger base is disposed at a first pixel line in which the number of the object areas is reduced after it has once been equal to or more than two.

According to another embodiment, the motion sensor may detect the motion of the object to be detected from the successively obtained synthetic images by utilizing other various tracking technologies, such as an optical flow.

Moreover, according to a modification, the image synthesis device and motion sensor may be separate devices. For example, the processing section 17 may omit execution of the object motion detection processing and instead output the generated synthesis images to the main control circuit or a presentation control circuit of the game machine. Then, the main control circuit or presentation control circuit may execute the object motion detection processing based on the received synthetic images. In this case, the main control circuit or presentation control circuit has functions of, e.g., the object area extraction section 24, reference point identification section 25, movable portion position detection section 26, and determination section 27. In this case, the object area extraction section 24, reference point identification section 25, movable portion position detection section 26, and determination section 27 may be omitted from the processing section 17.

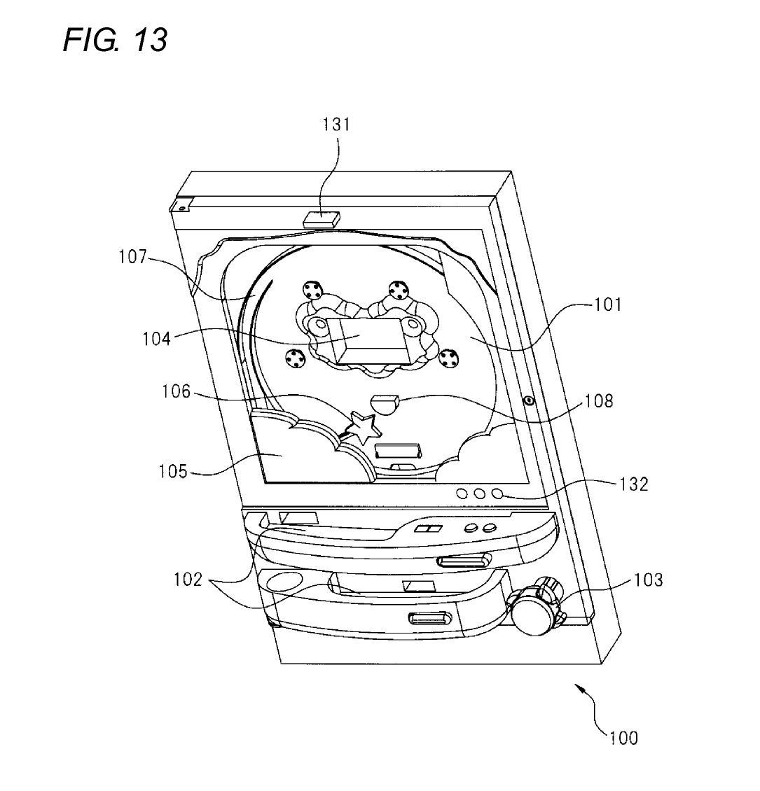

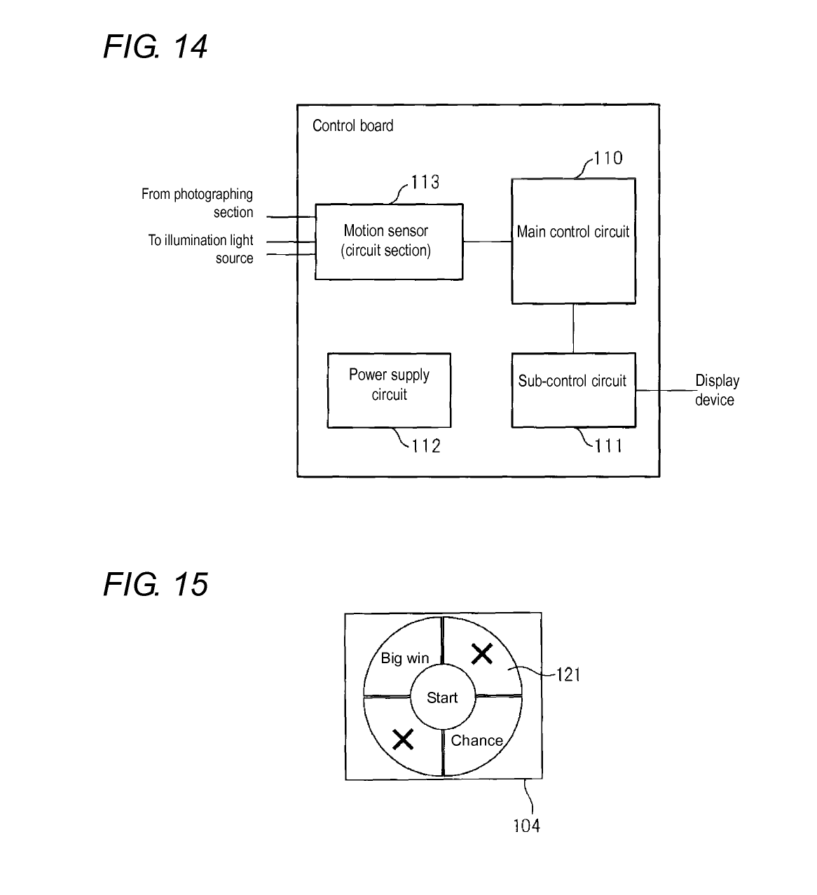

FIG. 13 is a schematic perspective view of a pinball game machine 100 provided with the motion sensor incorporating therein the image synthesis device according to the embodiment or modification of the present invention. FIG. 14 is a circuit block diagram of the pinball game machine 100. As illustrated in FIG. 13, the pinball game machine 100 includes a game board 101 as a game machine main body which ranges over a large part of the pinball game machine 100 from an upper portion thereof to a center portion, a ball receiving portion 102 provided below the game board 101, an operation section 103 provided with a handle, and a display device 104 provided at substantially a center portion of the game board 101.

Moreover, for a game presentation, the pinball game machine 100 includes a fixed accessory portion 105 provided on a front surface of the game board 101 at a lower portion thereof and a movable accessory portion 106 provided between the game board 101 and fixed accessory portion 105. Moreover, a rail 107 is provided at a side portion of the game board 101. Moreover, a large number of obstacle nails (not illustrated) and one or more prize winner devices 108 are provided on the game board 101.

As illustrated in FIG. 14, a control board is provided at a back of the pinball game machine 100. The control board includes a main control circuit 110 that controls the entire operation of the pinball game machine 100, a sub-control circuit 111 that controls components such as the display device 104 and a speaker (not illustrated) relevant to the game presentation, a power supply circuit 112 that supplies power to components of the pinball game machine 100, a circuit section (i.e., sections of the motion sensor according to the above embodiment other than the photographing section and illumination light sources) of the motion sensor 113 according to the embodiment or modification of the present invention.

Moreover, like the photographing section 13 of FIG. 2, a photographing section 131 is provided at the upper potion on a front surface of the game board 101. The photographing section 131 faces downward so as to be able to photograph a predetermined photographing range extending along the front surface of the game board 101. The photographing section 131 corresponds to the photographing section of the above-described image synthesis device and is constituted by, e.g., an infrared camera, and illumination light sources (not illustrated) for illuminating the photographing range are provided on left and right sides of the photographing section 131. Moreover, an illumination light source 132 is provided above the ball receiving portion 102. Upon reception of a photographing instruction from the circuit section of the motion sensor 113, the photographing section 131 photographs its photographing range with a predetermined photographing period to generate an image corresponding to the photographing range. At this time, the illumination light sources are alternately turned on in accordance with the photographing period in response to a control signal from the circuit section of the motion sensor 113. In this example, the image is generated such that an end portion of the photographing range on a side near the game board 101 corresponds to the upper end of the image, and an end portion of the photographing range on a side away from the game board 101 corresponds to the lower end of the image. The images generated by the photographing section 131 are sequentially transmitted to the circuit section of the motion sensor 113.

The operation section 103 shoots a game ball with a predetermined force from a not illustrated shooting device in accordance with a pivot amount of a handle based on operation of a player. The shot game ball goes upward along the rail 107 and falls down in a space with a large number of obstacle nails. When a not illustrated sensor detects that the game ball enters any of the prize winner devices 108, the main control circuit 110 provided at the back of the game board 101 pays out, through a ball payout device (not illustrated), the game balls to the ball receiving portion 102 by a number corresponding to a number set in the prize winner device 108 that the game ball has entered.

Moreover, the main control circuit 110 sends to the sub-control circuit 111 a control signal for starting the presentation in accordance with a motion of the player. Upon reception of the control signal, the sub-control circuit 111 makes the display device 104 display a guide message for the player to make a predetermined motion. Moreover, the main control circuit 110 transmits to the motion sensor 113 a control signal for instructing the motion sensor 113 to start detection of the player's predetermined motion.

For example, as illustrated in FIG. 15, in a case where the presentation is designed such that a roulette 121 displayed on a display screen of the display device 104 is stopped by the player's hand waving motion from a player's far side (a side near the game board 101) to a near side (a side away from the game board 101), the sub-control circuit 111 makes the display device 104 display a message saying “move your hand from far side to near side when roulette is rotated” for a certain time period (e.g., three seconds). Thereafter, the sub-control circuit 111 makes the display device 104 display a moving image of the rotated roulette for a certain input period (e.g., one minute). When the player makes the specified motion (hand waving motion from player's far side to near side) within the photographing range of the photographing section 131 during the input period, the motion sensor 113 successively generates, based on images from the photographing section 131, the synthetic images each in which the player's hand is easily identifiable and determines based on the synthetic images whether the specified motion is made.

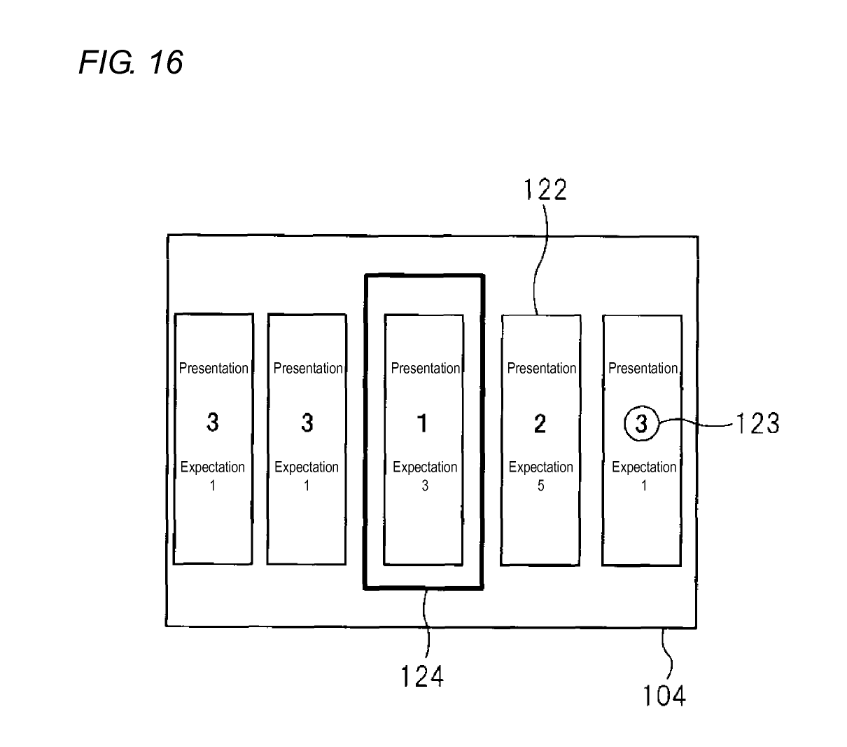

Alternatively, as illustrated in FIG. 16, the presentation may be designed such that a plurality of blocks 122, each representing a type of the presentation made when a big win comes, is moved from left to right on the display screen of the display device 104. In this case, the predetermined motion may be set to a waving of the hand from right to left. In this case, the sub-control circuit 111 makes the display device 104 display a message saying “move your hand from right to left” for a certain time period (e.g., three seconds). Thereafter, the sub-control circuit 111 makes the display device 104 display a moving image in which horizontally-arranged blocks are moved from left to right for a certain input period (e.g., one minute), as illustrated in FIG. 16. Each of the blocks is labeled with a level 1, 2, 3 representing the value of the presentation. When the player makes the specified motion (hand waving motion from right to left) within the photographing range of the photographing section 131 during the input period, the motion sensor 113 detects that the specified motion is made based on the synthetic images generated from the images from the photographing section 131.

When detecting that the specified motion is made, the motion sensor 113 sends a detection signal indicating the detection of the specified motion to the main control circuit 110. The main control circuit 110 executes lottery control of whether or not to generate a big win depending on a reception timing of the detection signal and a display content of the display device 104 at the reception timing. In a case where the specified motion cannot be detected within the input period, the main control circuit 110 executes the lottery control by utilizing an end timing of the input period in place of the reception timing of the detection signal.

Alternatively, the main control circuit 110 determines the presentation made when the big win comes depending on the reception timing of the detection signal and presentation level of a block displayed at a predetermined position (e.g., within a center frame 124 of FIG. 15) of the display device 104 at the reception timing.

The main control circuit 110 determines a presentation to be displayed on the display device 104 from among a plurality of previously prepared presentations depending on a result of the lottery control and sends a control signal corresponding to the determined presentation to the sub-control circuit 111. The sub-control circuit 111 moves the movable accessory portion 106 depending on the received presentation. Moreover, the sub-control circuit 111 reads moving image data corresponding to the received presentation from a memory (not illustrated) of the sub-control circuit 111. Then, the sub-control circuit 111 makes the display device 104 display the moving picture.

As described above, those skilled in the art can make various modifications according to the embodiment to be put into practice within the scope of the present invention.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. An image synthesis device comprising:
a first illumination light source configured to illuminate an object to be detected;
a second illumination light source disposed at a different position from the first illumination light source and configured to illuminate the object to be detected;
a light source controller configured to alternately turn on the first and second illumination light sources;
a photographing section configured to photograph the object to be detected while the first illumination light source is turned on to generate a first image in which the object to be detected is present and configured to photograph the object to be detected while the second illumination light source is turned on to generate a second image in which the object to be detected is present;
a storage section configured to store therein a first reference image generated by photographing a photographing range of the photographing section under conditions where the first illumination light source is turned on and where the object to be detected does not exist in the photographing range and a second reference image generated by photographing the photographing range under conditions where the second illumination light source is turned on and where the object to be detected does not exist in the photographing range;
a difference image generation section configured to generate a first difference image based on a difference between the first image and first reference image and a second difference image based on a difference between the second image and second reference image; and
a synthesis section configured to synthesize the first and second difference images to generate a synthetic image.

2. An image synthesis method comprising:
alternately turning on a first illumination light source and a second illumination light source disposed at a different position from the first illumination light source;
photographing an object to be detected using a photographing section while the first illumination light source is turned on to generate a first image in which the object to be detected is present;
photographing the object to be detected using the photographing section while the second illumination light source is turned on to generate a second image in which the object to be detected is present;
generating a first difference image based on a difference between the first image and a first reference image generated by photographing a photographing range of the photographing section under conditions where the first illumination light source is turned on and where the object to be detected does not exist in the photographing range;
generating a second difference image based on a difference between the second image and a second reference image generated by photographing the photographing range under conditions where the second illumination light source is turned on and where the object to be detected does not exist in the photographing range; and
synthesizing the first and second difference images to generate a synthetic image.
